(19) United States
(12) Patent Application Publication
(10) Pub. No.: US 2013/0102428 A1
(43) Pub. Date: Apr. 25, 2013

(54) FLYER CHAIN

(71) Applicant: Rexnord Kette GmbH, Betzdorf (DE)

(72) Inventors: FRANZ JOSEPH HOLSCHBACH, Wallmenroth (DE); RALF STEUP, Betzdorf (DE); PETER BAUMEISTER, Brachbach (DE); ULRICH GERLACH, Wissen (DE); JÖRG HEUER, Betzdorf (DE); JÖRG LINDEMAIER, Schwerte (DE)

(73) Assignee: Rexnord Kette GmbH, Betzdorf (DE)

(21) Appl. No.: 13/657,386

(22) Filed: Oct. 22, 2012

(30) Foreign Application Priority Data
Oct. 24, 2011 (DE) 10 2011 116 700.9

(51) Int. Cl. F16G 13/06

(52) U.S. Cl. 474/206

(57) ABSTRACT

A flyer chain includes outer-, inner-, and intermediate plate-links, and a chain bolt, wherein the outer-, inner-, and intermediate plate-links are arranged in a single-lacing, and wherein a clearance fit is established between the chain bolt and the outer plate-links

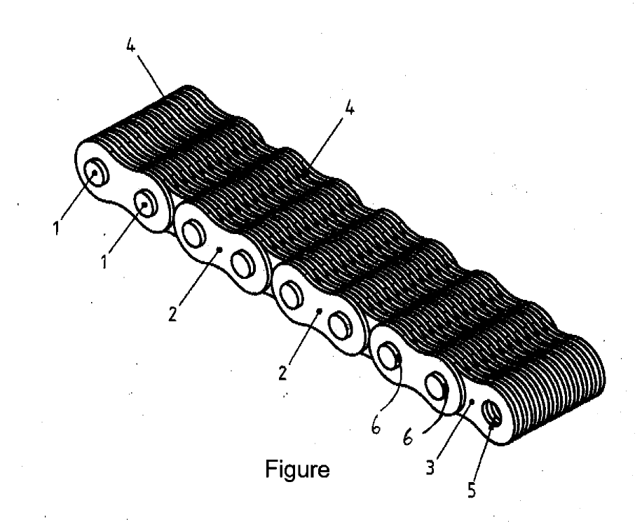

### CROSS-REFERENCES TO RELATED APPLICATIONS

This application claims the priority of German Patent Application, Serial No. 10 2011 116 700.9, filed Oct. 24, 2012, pursuant to 35 U.S.C. 119(a)-(d), the disclosure of which is incorporated herein by reference.

### BACKGROUND OF THE INVENTION

The present invention relates to a flyer chain.

The following discussion of related art is provided to assist the reader in understanding the advantages of the invention, and is not to be construed as an admission that this related art is prior art to this invention.

A flyer chain which is also referred to as plate-link chain is a safety relevant component which is a load chain or safety lifting chain which usually serves as pulling unit for deflecting forces. The flyer chain is used in conjunction with hydraulically actuated cylinders or as counter weight chain. It ensures a high load bearing capacity in lifting devices and is most commonly used in lift masts of fork lifts. It also serves further important functions as counter weight chain in machine tools and as lifting chain in container lift cars.

A flyer chain is formed by chain bolts and plate-links in which distinction is made between outer, inner and intermediate plate-links, wherein the plate-links are lined up on the chain bolt in arrangements which for example are predetermined by norms such as ISO 4347.

Each chain link of a flyer chain is composed of outer plate-links and inner plate-links or intermediate plate-links which are pivotally connected to one another by chain bolts thereby forming a pivot joint. The outer plate-links usually have a press fit, wherein the chain bolts which are pressed into the outer plate-links can be additionally riveted. A press fit is established between the chain bolts and the outer plate-links. In order to ensure the pivotabilti_{y}, the inner and intermediate plate-links are usually provided with a sliding fit so that a clearance fit is established between the chain bolt and the inner- or intermediate plate-links. Such a flyer chain is known from DE 34 31 317 C2.

The wear life of a flyer chain depends on many factors, such as for example the friction in the chain joint, which is for example influenced by the lubrication, the number of joint movements and the joint surface pressure.

It would be desirable and advantageous to provide an improved flyer chain whose service life is increased by decreasing the wear in the joint.

### SUMMARY OF THE INVENTION

According to one aspect of the present invention, a flyer chain includes outer-, inner-, and intermediate plate-links and a chain bolt, wherein the outer-, inner-, and intermediate plate-links are arranged in a single-lacing, and wherein a clearance fit is established between the chain bolt and the outer plate-links.

The invention is based on the idea that contrary to the previous conception and contrary to the previously accepted norm, a single-lacing of the plate-links of the flyer chain is used. Single-lacing means here that there are no two tightly adjacently arranged intermediate or inner plate-links which are arranged on the same chain bolt. Intermediate and inner plate-links constantly alternate transversely to the longitudinal extension of the flyer chain on a chain bolt. The arrangement of the plate-links in single-lacing causes the pulling force to be distributed very evenly across the length of the chain bolt so that local tension peaks which lead to an increased wear are significantly reduced. The resulting increased wear life is associated with an increase of the rigidity of the flyer chain. In addition, a single-lacing allows a scaling of the chain width so that the plate-link cross section that is required for the actual expected load can be provided at high capacity utilization. Due to the optimized scaling, the vision of the fork lift driver is minimally impaired when using the flyer chain on a lift mast of a fork lift, because the flyer chain which is arranged in the visual field can be configured smaller.

It has further surprisingly been shown that by overcoming the previous norm by now providing a single-lacing, the joint surface pressure can be decreased which leads to an increase of the wear life. The joint surface pressure is the ratio of chain pulling force to joint surface, which represents a mathematical value which projects the projected surface of the chain bolt onto the inner plate-link bores. Thus, the joint surface results from the product of the chain bolt diameter, the plate-link thickness and the number of the movable inner plate-links. Decreasing the number of the intermediate plate-links allows increasing the joint surface.

A clearance fit exists between the chain bolt and outer plate-links of the flyer chain. The clearance fit allows significantly decreasing the bending of the chain bolt in case of a transverse load by the plate-links that act on the chain bolt. The rotatability of the chain bolt in the chain joint increases the joint surface by the surface which was otherwise used up by the chain bolt in the press fit and on the intermediate plate-links. Further, the rotatability of the chain bolt increases the surface which is available for the wear to the entire sheath surface of the chain bolt. The wear life of the flyer chain is further increased.

The single-lacing allows generating a scaling of the capacity at low component-variety via the number of the plate-links which are alₜernately arranged on the bolt.

Preferably all plate-links of the flyer chain have the same geometry with regard to the division (the distance of the center of the through-openings of an outer plate-link for the chain bolts) and to the diameter of through opening of the plate-link for the chain bolt. This allows for easier manufacturing of the flyer chain, because all plate-links of the flyer chain have the same configuration.

Preferably, the axial securing of the chain bolt can be achieved by an axial securing element. The axial securing element can be realized as a clamping disc, a spring disc or by a plastic deformation of the chain bolt ends.

### BRIEF DESCRIPTION OF THE DRAWING

Other features and advantages of the present invention will be more readily apparent upon reading the following description of currently preferred exemplified embodiments of the invention with reference to the accompanying drawing, in which the sole FIGURE shows a schematic representation of a flyer chain according to the invention.

### DETAILED DESCRIPTION OF PREFERRED EMBODIMENTS

Throughout all the FIGURES, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

Turning now to the drawing, the sole FIGURE schematically shows a flyer chain according to the invention. The flyer chain includes chain bolts 1 and plate-links which are lined up on the chain bolts 1.

The plate-links include outer plate-links 2, inner plate-links 3 and intermediate plate-links 4. The outer plate-links 2 delimit the flyer chain laterally outwardly. The intermediate plate-links 4 are plate-links which are arranged on the same chain bolts 1 of an outer plate-link 2. The inner plate-links 3 are lined up on the flyer chain with their through openings 5 so that each inner plate-link 3 receives one chain bolt of two consecutive outer plate-links.

In the flyer chain according to the invention shown in the FIGURE, the outer plate-links 2, intermediate plate-links 4 and inner plate-links 3 are lined up on the chain bolt 1 in single-lacing.

In the exemplary embodiment in the FIGURE, a clearance fit exists between the chain bolts 1 and the outer plate-links 2. The chain bolts 1 are secured on the outer plate-link 2 by a securing element which is formed by a plastic deformation 6 of the chain bolt ends.

In the exemplary embodiment shown in the FIGURE, the intermediate plate-links 4, inner plate links 3 and outer plate-links 2 have the same geometry, in particular with regard to the division and the diameter of the through opening 5. The intermediate plate-links 4, inner plate-links 3 and outer plate-links have the same configuration.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A flyer chain comprising:
outer-, inner-, and intermediate plate-links; and
a chain bolt, wherein the outer-, inner-, and intermediate plate-links are arranged in a single-lacing, and wherein a clearance fit is established between the chain bolt and the outer plate-links.

2. The flyer chain of claim 1, wherein the outer chain links and inner chain links have a same geometry.

3. The flyer chain of claim 2, wherein the intermediate plate-links have a same geometry as the inner plate-links.

4. The flyer chain of claim 1, further comprising an axial securing element for securing the chain bolt on the outer plate-links.
